(19) United States
(12) Patent Application Publication
(10) Pub. No.: US 2004/0172180 A1
(43) Pub. Date: Sep. 2, 2004

(54) Wireless communications device for use in tires

(76) Inventor: Tom W. Bowman, Charlotte, NC (US)

Correspondence Address: CALFEE HALTER & GRISWOLD, LLP, 800 SUPERIOR AVENUE, SUITE 1400, CLEVELAND, OH, 44114, US

(21) Appl. No.: 10/760,772

(22) Filed: Jan. 20, 2004

Related U.S. Application Data
(60) Provisional application No. 60/441,439, filed on Jan. 21, 2003.

(51) Int. Cl. G06F 17/00

(52) U.S. Cl. 701/29; 701/2; 701/33

(57) ABSTRACT

A tire having one or more belt wires and a microchip or an RFID tag is provided. The microchip is embedded in the tire and is in circuit communications with one or more belt wires. The one or more belt wires provide an antenna for the microchip and allow the microchip to communicate with a read/write device via the belt wire antenna. In addition, preferably, the microchip is configured to allow the storage of information or data related to the tire manufacturing process so that the information can be retrieved at a later date. In addition, preferably the microchip is capable of receiving information relating to the tire and communicating the information via the belt wire antenna.

### CROSS-REFERENCE TO RELATED APPLICATIONS

This application claims priority to and all other benefits of U.S. Provisional Application No. 60/441,439 filed on Jan. 21, 2003 entitled Wireless Communications Device for Use in Tires, which is hereby incorporated by reference in its entirety.

### FIELD OF THE INVENTION

The present invention relates to wireless communications devices, and more particularly to a microchip that uses one or more of the belt wires in the tire as an antenna.

### BACKGROUND

Wireless communications devices, including wireless memory devices for storing and retrieving data, such as radio frequency identification (RFID) tags, are well known. One use for RFID tags is to identify items and/or track items in inventory. An RFID tag is affixed to an item and information pertaining to that item is transmitted to the RFID tag by a read/write device. The information is stored on the RFID tag and can later be retrieved by other read/write devices permitting the user to identify individual items or track inventory. RFID tags are available from a number of manufacturers, including Intermec Technologies Corp. of Everett Washington, Texas Instruments of Dallas, Tex., and Micron Communications, Inc. of Boise, Id. The term “RFID tag” is generally used to describe an electronic structure, such as an integrated circuit or microchip that is coupled to an antenna.

RFID tags can be active, passive or a combination thereof. True passive tags do not contain a battery and are generally less expensive to manufacture; however, passive tags require an outside source to provide power. Passive tags use electromagnetic energy that is radiated by an interrogator to power the radio frequency circuit. Active tags include a radio transmitter and a battery to power the transmitter. Generally, active tags have a greater range then their passive counterparts. However, active tags are more expensive to manufacture and the batteries must be replaced periodically. Passive tags that contain a battery are active/passive. This type of tag has some of the enhanced attributes of a true active tag, but still communicates by the same method as true passive tags. Active/passive tags are complex integrated circuits with multiple components and are more expensive to manufacture.

Antenna structures that are combined with microchips to form an RFID device come in a variety of sizes and shapes and occasionally employ parasitic or passive antenna elements that electromagnetically cooperate with the active antenna element to enhance the transmission or reception of the signal. An active antenna is driven by a transmitter to transmit data and/or is driven by a signal from an external source to receive data. Parasitic antenna elements typically include an array of directors and reflectors, with the directors generally being shorter, and the reflectors generally being longer than the driven element. Typically the parasitic antenna elements need to be carefully aligned and carefully spaced apart from the driven antenna, as well as from each other, at a space of approximately one-quarter wave of the length that corresponds to the operating frequency of the antenna.

The US Department of Transportation (DOT) has developed new requirements for automakers and tire manufactures that require them to track certain information regarding the tires that are installed on new vehicles. The information that the DOT requires to be tracked includes the week, year, place of manufacture, the tire size, and other unique attributes of the tire, and, in addition, may soon include information related to the type of vehicle on which the tire is installed. As a result, tracking tire data has become a top priority in the tire manufacturing industry.

Tire manufacturers track the information regarding the tires, information such as builder number and machine number are often printed on stickers that are affixed to the inside of the tire. Other information, such as plant location, style, size and serial number are molded into the side wall of the tire. The vehicle manufacturer can read this information prior to installation and correlate this information with the particular vehicle. However, the tire must be removed from a vehicle to read this information. In addition, some tire manufactures employ a standard bar code system to track the tires during the manufacturing process. The bar code system eliminates some manual labor in tracking the tires. Temporary RFID tags have also been affixed to the outside surface of the tire and are typically attached with an adhesive. Removing such temporary RFID tags leaves a sticky residue on the tire that must be cleaned off prior to putting the tire in service which increases labor costs. Once the temporary RFID tag or bar code is removed, a user must look to the inside of the tire to find the manufacturing data.

It is known to adhere an RF device and its antenna to the inner liner of a completed tire, see, e.g. U.S. Pat. Nos. 6,208,244 B1 and 6,217,683 B1. Generally, RFID tags employ antennas that are constructed of heavy gauge single conductor wire or flat solid lengths of metal. As a consequence, permanently installing RFID devices to the inside surface of tires during the manufacturing process has been problematic. Common problems include damage to the antennas during the manufacturing process and/or during the constant tire-flex that occurs during normal operation. Oftentimes the transmitter fails and, in addition, the broken antenna may damage the tire and its components. Consequently permanently adding such foreign matter to the inside surface of the tire is undesirable.

The Automotive Industry Action Group (AIAG) is currently developing standards for tracking of the tires. The new tire tracking standard will be based on the American National Standards Institute's (ANSI) material handling specifications (MH 10.8.4). The new standards will be designed to simplify and speed up verification of tire warranties, and, perhaps more importantly, the new standards will enhance safety and, decrease inconvenience by permitting selective recalls that only remove specific tires from the roads. One way to accomplish this is using information from an RFID device permanently affixed to the tire.

In addition to tracking the tire data, monitoring the condition of tires, especially tire inflation pressures, has become increasingly important. In fact, government regulations may soon require all new vehicles to be equipped with tire pressure monitoring devices. Maintaining proper tire pressure results in safer vehicle operation, better gas mileage and increased life of the tire. Similarly, monitoring other tire conditions, such as temperature and tread wear, can be used to make travel safer. In addition, the new “no flat” tires, or “run flat” tires, are designed to operate for brief periods of time after loss of tire pressure. Continued operation without air pressure, however, results in the failure of the tire, which poses a problem if the operator is not aware of the loss of tire pressure. As a result, it is desirable for vehicle operators to be notified of loss of tire pressure that has occurred from a puncture or slow leak.

Tire pressure monitoring systems are known. A typical example includes a small low power transmitter and pressure sensor located on each tire. Each tire pressure sensor transmits its tire pressure to a receiver located on the vehicle. The Receiver supplies all of the tire pressure values and alarms to a central monitor and display. The display is generally located in the passenger cabin of the automobile to provide the operator with the critical information as quickly as possible. Other devices used for monitoring tire conditions include self-powered circuits that are positioned externally of the tire, such as in the valve stem.

Various attempts have been made to develop RF devices to monitor tire pressure. Self-powered tire monitoring RF circuits include an antenna to transmit the signal from the tire to a receiving device located on the vehicle. The transmitters must be low powered to conserve battery life, and, as a result, have a limited useful Read/Write transmission distance. Placement of the antenna so that the data created by the monitoring device is accurately transmitted to the receiving device located on the vehicle is critical and has been problematic. Some conventional monitoring device antennas extend into the chamber of the tire. This placement forces the transmitted signal to pass through the air in the tire, the inner-liner, the side wall and through the outside air to the receiving device.

In addition, the bead ring, apex filler and carbon content of the tire tend to inhibit the passage of radio waves as they are transmitted from a monitoring device to the receiver. As a result, it is desirable to position the antenna as far away from the bead ring as possible. A preferred position for the antenna is in the middle of the sidewall, however, this area is subjected to greater forces from stretching and shock during operation, which may result in damage to the transmitting device and antenna. Other RF devices are integrated in a patch that is adhered to the inner-liner of the tire after the tire is made. This method of installing the monitoring device adds costs and steps to the manufacturing process. As a result, it is desirable for the monitoring device to be installed during the manufacturing process and integrated as part of the tire. As discussed earlier, however, the manufacturing process subjects the antenna of the transmitting device to stretching and abuse which may result in failure of the device and possible damage to the tire or its components.

### SUMMARY

A wireless communications device that can be used to transmit and/or receive information relating to a tire is provided. The wireless communication device may easily be integrated with any tire such as one having a tread, a sidewall and two or more wire-belts. The wireless communications device includes a microchip coupled to one or more of the wires that make up the wire-belts. Preferably, the microchip is an integrated circuit that includes a processor, a transmitter/receiver and a memory. One or more of the wires in the wire-belt serve as the antenna for the microchip and together form a wireless communications device.

In one embodiment, the microchip is electrically coupled to one or more of the belt wires and integrated into the tire during the manufacturing process. Data, such as the time and place of manufacture, can be transmitted to the wireless communications device and stored in the memory. The data can be stored on the wireless communication device before, during or after the tire manufacturing process. Other relevant information, such as the type of vehicle the tire is installed on, can be stored on the wireless communications device at a later time. The wireless communications device can be interrogated at any time by a read/write device to retrieve the stored information.

In addition, sensors, such as pressure and temperature sensors, can be coupled to, or integrated with, the microchip of the wireless communications device. The sensors monitor the tire during use and transmit the relevant information via the belt wire antenna to a read/write device where the data can be processed and presented to the user.

Thus, a wireless communication device that is low cost and eliminates the need to add a bulky antenna to the tire is provided. The wireless communications device can be permanently integrated into the tire permitting the tire to be easily identified throughout its life. Thus anyone with a read/write device can track the tire from the manufacturing process to the end user and to the tire disposal site. If the manufacturer can identify a particular line or date of manufacturing defects it can limit the scope of any necessary tire recall. Limiting the scope of the tire recall results in significant savings for the manufacturer, and increases public safety by quickly removing defective tires from the roadway. In addition, the device can be used to identify the owner of tires that are illegally dumped and polluting the environment.

### BRIEF DESCRIPTION OF THE DRAWINGS

FIG. 1 is a cross sectional view of one embodiment illustrating a wireless communications device embedded in the tire using a belt wire as an antenna.

FIG. 2 is a plan view of one embodiment illustrating a wireless communications device embedded in the tire using a belt wire as an antenna.

FIG. 3 is a high-level block diagram of one embodiment illustrating an active microchip using a belt wire as an antenna.

FIG. 4 is a high-level block diagram of one embodiment illustrating a passive microchip using a belt wire as an antenna.

FIG. 5 is a high-level block diagram of one embodiment illustrating an active microchip with an integrated sensing device and using a belt wire as an antenna.

### DETAILED DESCRIPTION OF THE DRAWINGS

A typical wireless communications device, such as an RFID device, RFID tag, or transponder includes an integrated circuit or microchip that is coupled to an antenna. While the embodiments described herein relate to radio frequency devices, this is merely for convenience of description, and any device that communicates via electromagnetic radiation may be used without departing from the spirit and scope of the invention. The integrated circuit or microchip portion of the wireless communications device can be very small, and in some cases is approximately one half the size of a grain of rice. The microchips generally store between 64 and 128 bits of data, and can include read only memory (ROM), write to once and read many times (WORM) memory, read-write memory or random access memory (RAM) that can be written an overwritten numerous times, or any combination thereof. A typical microchip has prongs extending from it that are in circuit communication with the microprocessor. The prongs are commonly electrically coupled to an antenna to facilitate communications between the microchip and an external read/write device or interrogator. The references to an “read/write” device herein refer to an interrogation device that can read/write, read only, and/or write only information to or from the microchip and a reference to one but not the other is not meant to limit the spirit and scope of the claimed invention.

“Circuit communication” as used herein indicates a communicative relationship between devices. Direct electrical, electromagnetic, and optical connections and indirect electrical, electromagnetic, and optical connections are examples of circuit communication. Two devices are in circuit communication if a signal from one is received by the other, regardless of whether the signal is modified by some other device. For example, two devices separated by one or more of the following-amplifiers, filters, transformers, optoisolators, digital or analog buffers, analog integrators, other electronic circuitry, fiber optic transceivers, or even satellites-are in circuit communication if a signal from one is purposefully communicated to the other, even though the signal is modified by the intermediate device(s). As another example, an electromagnetic sensor is in circuit communication with a signal if it receives electromagnetic radiation from the signal. As a final example, two devices not directly connected to each other, but both capable of interfacing with a third device are in circuit communications e.g., memory connected to a central processing unit CPU is in circuit communication with an input device that is connected to the CPU.

“Microprocessor” as used herein, also referred to herein as just processor, may be one of virtually any number of processor systems and/or stand-alone processors, such as microprocessors, microcontrollers, digital signal processors, central processing units (CPUs), distributed processors, bit slice processors, and complex state machines, and has associated therewith, either internally therein or externally in circuit communication therewith, associated memory, clocks, decoders, memory controllers, and/or interrupt controllers, etc. known to those in the art to be needed to implement a processor circuit.

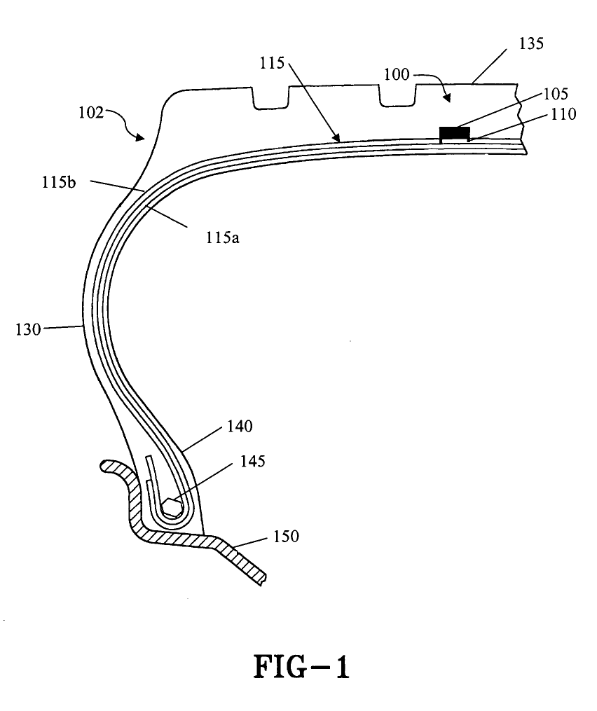

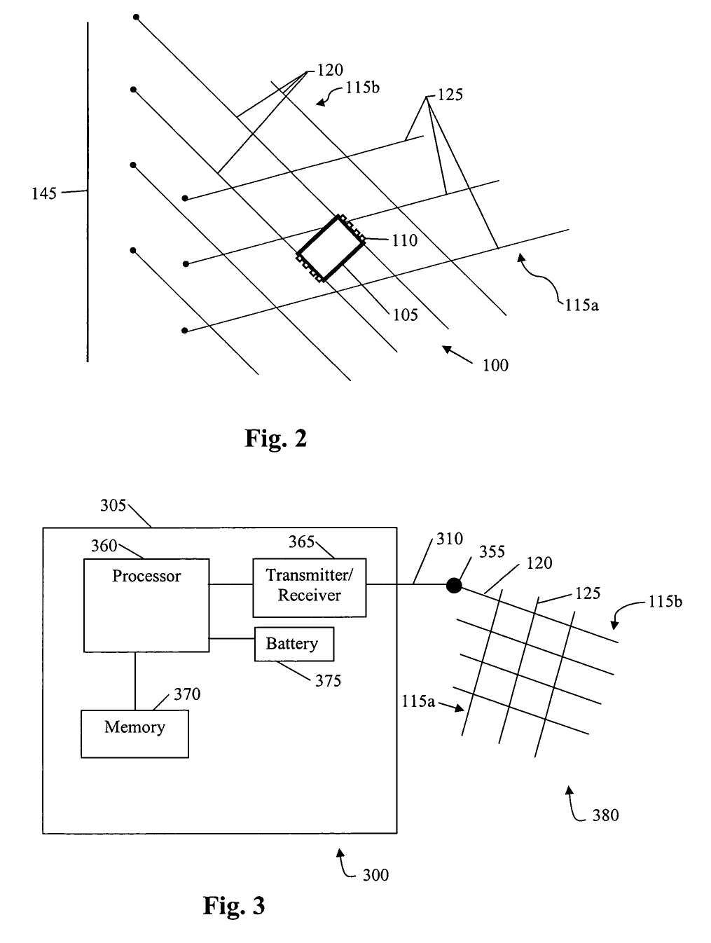

FIG. 1 illustrates a cross sectional view of a tire 102 with an integrated wireless communications device 100. Preferably, the tire 102 includes a tread portion 135, a side wall 130, two or more wire-belt layers 115, an inner-liner 140 and two bead rings 145. A first plurality of belt wires 125 make up a first wire-belt layer 115a, and a second plurality of belt wires 120 make up a second wire-belt layer 115b (FIG. 2).

The tire 102 is shown mounted on a rim 150. For convenience and clarity only a portion of the tire 102, rim 150, and one bead ring 145 are shown in the illustration of FIG. 1. The bead ring 145 encircles the opening of the tire 102 and prevents the tire from deforming and slipping off of the rim 150 when the tire is inflated. The wire-belt layers 115 add strength and durability to the tire 102. The tread 135 is configured to provide traction and permit tire wear. The sidewall 130 spans the distance from the tread 135 to the rim 150, and the inner-liner 140 covers the entire inside surface of the tire.

Embedded in the tire 102 is a microchip 105 with prongs 110 that are coupled to one or more belt wires, preferably one or more belt wires 120 in the second wire-belt layer 115b. The microchip 105 can be either mechanically coupled or electrically coupled to the belt wires 120 in any conventional manner. Thus, the belt wires 120 form an antenna for the microchip 105 and data can be transmitted to and from the microchip 105 via the belt wire antenna by electromagnetic radiation, such as radio frequency.

For purposes of this discussion, a conventional tire having wire-belt layers has been described, but any tire fabricated with an internal conductive material to which a microchip may be coupled is meant to be within the spirit and scope of the present invention. The microchip may be mechanically or electrically coupled to the conductive material in substantially the same manner as is described herein in relation to the belt wires so that the conductive material becomes an antenna for the microchip.

Once the microchip 105 is coupled to the belt wires 120, the belt wires 120 form the antenna for the microchip completing the wireless communications device 100. By integrating the microchip 105 into the tire 102 and utilizing the belt wires 120 as an antenna the amount of foreign material introduced in the tire is significantly less than the amount of foreign material that is introduced in the tire with a conventional wireless communications device and its associated antenna. The microchip 105 is preferably small enough that it can be embedded in the tire 102 without significantly increasing the risk of premature failure of the tire 102 due to the addition of foreign material. In addition, integrating microchip 105 into the tire 102 during the manufacturing process reduces labor costs, such as those associated with separately fabricating and installing the wireless communications device, i.e., connecting a microchip to an antenna and embedding the device in a patch, and adhering the device to the tire 102 after the complete tire has been manufactured.

The wireless communications device 100 can be installed anywhere in tire 102 that permits microchip 105 to be coupled to one or more of the wires in one of the wire-belt layers 115 or a conductive material. Locating microchip 105 in the center of the tire 102 below the tread is ideal, however, for monitoring the temperature of the tire 102. Microchip 105 can have integrated sensors, such as a temperature sensor, pressure sensor, and/or distance sensor, or external sensors (not shown) coupled thereto or integrated therein. Monitoring the temperature of the tire can be used to trigger an alarm to the vehicle operator signifying that a problem is developing in the tire that could result in tire failure. The microchip 105 can also be programmed to monitor the distance between the microchip 105 and the rim 150. Monitoring this distance can be used to monitor the loading on the tire 102 and trigger an alarm if the tire 102 is in an overloaded condition. For example, if the distance from the microchip 105 to the rim 150 is reduced to 60% of the normal distance, an alarm could be triggered. In addition, the microchip 105 can be programmed to monitor the pressure in the tire 102 and trigger an alarm if the tire pressure falls below a threshold limit.

The wireless communications device 100 is capable of receiving and processing instructions transmitted by an interrogator or read/write device (not shown). The wireless communications device 100 receives an instruction, if within range, processes the instruction and transmits a response, if appropriate. Preferably, the interrogation signal and the responsive signal are electromagnetic radiation, such as radio-frequency (RF) signals produced by one or more RF transmitter circuits. Preferably, the interrogator or read/write device (not shown) is a hand held unit and/or includes one or more units mounted along the manufacturing line that are configured to read and write manufacturing data to the wireless communications device 100. In addition, an interrogator can be mounted on the vehicle for requesting and receiving relevant information from the sensors that are in circuit communication with the wireless communications device 100.

FIG. 2 illustrates a plan view of one embodiment in which the wireless communications device 100. The microchip 105 is placed on top of the second wire-belt layer 115b, with the prongs 110 face down into the second belt-wire layer 115b. The prongs 110 are electrically coupled to one or more of the second belt wires 120 using a conventional mechanical connection, such as, with solder or crimp connectors, or in the alterative the prongs are in close enough proximity to be electrically coupled to the belt wires 120. The rubber and other tire components secure the microchip 105 in place. In addition, conductive extensions (not shown) can be secured to the prongs 110 of the microchip 105 so that the prongs 110 extend across, and can be coupled to, a plurality of belt wires 120 in the second belt layer 115b.

One embodiment is illustrated in FIG. 3 depicting a high level block diagram of an active wireless communication device 300. The wireless communication device 300 includes a microchip 305 coupled to one or more belt wires. Preferably the microchip 305 is placed in circuit communication with the belt wires 120 in the second wire-belt layer having the belt wires 120 act as a belt wire antenna 380. Preferably the prongs 310 of the microchip 305 are mechanically coupled to the belt wires 120 in the second wire-belt layer 115b. As noted above, the mechanical coupling 355 can be achieved in any conventional connection manner, such as a soldered joint or a crimp connection, or merely being in close enough proximity, as described above.

Microchip 305 includes a transmitter/receiver 365, a battery 375, and memory 370 all in circuit communication with a micro processor 360. The transmitter/receiver 365 receives radio frequency (RF) signals from an interrogator or read/write device (not shown) via the belt wire antenna 380. The transmitter/receiver 365 converts the RF signal to data and communicates the data to processor 360 wherein the data is received and processed. The processor 360 stores the processed data in the memory 370; preferably the memory 370 is WORM memory. Thus, the data relating to the tire manufacture, such as date and place of manufacture can be permanently stored once and is unchangeable thereafter but can be read as often as required. The processor 360 can formulate response data, if required, and communicate that response data to the transmitter/receiver 365. The transmitter/receiver converts the response data to an RF signal and communicates the signal, via the belt wire antenna 380, to the interrogating device. Preferably, the power required by the wireless communication device circuit is supplied by the battery 375.

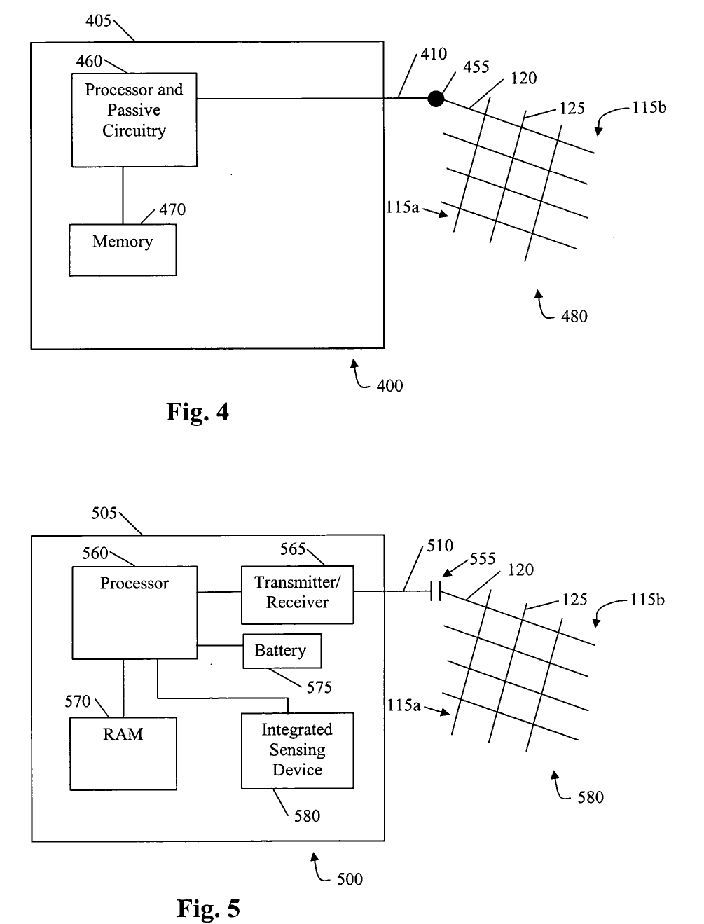

FIG. 4 illustrates another embodiment having a passive wireless communications device and belt wire antenna. The embodiment is similar to the embodiment described above, with the exception that the device in FIG. 4 is a passive wireless communications device 400 and does not need a power supply or battery. The passive wireless communications device 400 includes a microchip 405 coupled to a belt wire antenna 480. Preferably, antenna prongs 410 of microchip 405 are coupled to belt wires 120 of the second wire-belt layer 115a with a mechanical coupling 455. Still more preferably the mechanical coupling 455 is a solder connection. The microchip 405 includes memory 470 in circuit communication with a passive circuit 460. In this embodiment, power is provided to the circuit via an external RF transceiver.

An interrogator or reader used with a passive RFID device is commonly referred to as an RF transceiver. An RF transceiver controls and modulates radio frequencies that are transmitted and received via an antenna. The passive circuit 460 receives RF signals from the transceiver via the belt wire antenna 480. The electromagnetic RF signals supply power as well as information to the circuit. The passive circuit 460 converts the RF signal to data and communicates the data to the processor 460. The processor 460 is programmed to receive the data and either store the information as described above in the memory 470 or formulate response data and communicate the response data to the transponder (not shown). The passive circuit 460 emits response data in the form of a backscatter signal that is filtered and amplified by the RF transceiver.

Finally, FIG. 5 illustrates yet another embodiment, similar to that described in relation to FIG. 3 above, in which a wireless communications device 500 includes a microchip 505 electrically coupled 555 to the second belt wire layer 120 of the tire 102. An electrically coupled connection does not require a direct physical connection between the prongs 510 and the belt wire 120 of the second wire-belt layer 115b. The prongs 510 need only to be sufficiently aligned and close to the antenna, such as the second wire-belt layer 115b, so that the resulting electrical coupling provides the necessary communication between the belt wire antenna 580 and the microchip 505. As described above, an extension (not shown) can be connected to the microchip prongs 510 so that the prongs 510 reach across several of the belt wires 120 in the second belt layer 115b.

Microchip 505 includes a transmitter/receiver 565, a battery 575, memory 570, and an integrated sensing device 580, all in circuit communication with a micro processor 560. The transmitter/receiver 565 receives an RF signal from an interrogator (not shown) via the belt wire antenna 580, converts the signal to data and communicates the data to the processor 560. The processor 560 is programmed to receive and process the data. In addition, the processor 560 can obtain and process data from the integrated sensing device 580. The processor 560 stores the processed data in the memory 570; preferably the memory 570 includes both WORM memory and programmable memory. Thus the data containing information relating to the tire manufacture, such as date and place of manufacture can be permanently stored in the memory, and information pertaining to the status of the tire 102 received from the integrated sensing device 580 can be updated as often as required. Preferably, the processor 560 formulates a response based upon the stored manufacturing data, or formulates a response in accordance with data obtained from the sensing device 580. The sensing device 580 is any conventional sensing device, such as a pressure sensor, a temperature sensor, a distance sensor etc. In addition, the sensing device need not be integrated in the microchip 505 and can be external of the microchip 505 and mechanically or electrically coupled to the microchip 505. The transmitter/receiver 565 converts the data to an RF signal and communicates the signal, via the belt wire antenna 580, to the interrogator (not shown). The circuit is an active RFID device and is powered by the battery 575.

While the present invention has been illustrated by the description of embodiments thereof, and while the embodiments have been described in some detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described above. Accordingly, departures may be made from such details without departing from the spirit or scope of the applicant's general inventive concept.

What is claimed:

1. A tire, comprising:
one or more belt wires; and
a microchip embedded in the tire;
wherein the microchip is in circuit communication with at least one belt wire and is capable of communicating data using the at least one belt wire as an antenna.

2. The tire of claim 1 wherein the microchip is configured to transmit data via the at least one belt wire.

3. The tire of claim 1 wherein the microchip is configured to receive data via the at least one belt wire.

4. The tire of claim 1 wherein the microchip is embedded in a tread of the tire.

5. The tire of claim 1 wherein the microchip is embedded in a sidewall of the tire.

6. The tire of claim 1 wherein the microchip comprises passive circuitry.

7. The tire of claim 1 wherein the microchip comprises active circuitry.

8. The tire of claim 1 wherein the microchip comprises both active and passive circuitry.

9. The tire of claim 1 further comprising a sensor for sensing at least one tire parameter, wherein the microchip is capable of receiving the sensed at least one tire parameter and communicating the sensed at least one tire parameter via the one or more belt wires.

10. The tire of claim 9 wherein the sensor comprises a pressure sensing device capable of sensing an air pressure parameter.

11. The tire of claim 9 wherein the sensor comprises a temperature sensing device capable of sensing a tire temperature parameter.

12. The tire of claim 9 wherein the sensor comprises a distance detecting device capable of sensing a distance parameter.

13. A tire comprising:
at least one belt wire;
a source of power, and
a wireless communications means powered by the source of power for communicating data using the at least one belt wire as an antenna.

14. The tire of claim 13 wherein the source of power comprises a battery.

15. The tire of claim 13 wherein the source of power comprises circuitry for receiving power from an external read/write device.

16. The tire of claim 13 wherein the wireless communications means comprises an RFID tag for communicating data using the at least one belt wire as an antenna.

17. A method of manufacturing a tire comprising the steps of:
embedding a microchip in a tire, the microchip having a memory and being in circuit communications with one or more belt wires of a tire, the microchip capable of communicating data using at least one belt wire as an antenna; and
storing data on the microchip, wherein the data is capable of being retrieved at a later date using the at least one belt wire as an antenna.

18. The method of claim 17 further comprising storing a place of manufacture on the microchip.

19. The method of claim 17 further comprising storing a time of manufacture on the microchip.

20. The method of claim 17 further comprising storing a manufacturing lot number on the microchip.

21. The method of claim 17 further comprising storing plant-specific information on the microchip.

22. The method of claim 17 wherein the embedding step comprises positioning the wireless communications device in a tread of the tire.

23. The method of claim 17 wherein the embedding step comprises positioning the wireless communications device in a side wall of the tire.

24. The method of claim 17 wherein the embedding step comprises positioning the microchip between two layers of the tire.
